(19) United States
(12) Patent Application Publication
(10) Pub. No.: US 2015/0373283 A1
(43) Pub. Date: Dec. 24, 2015

(54) PHOTOGRAPHING SYSTEM, PHOTOGRAPHING METHOD, AND COMPUTER-READABLE STORAGE MEDIUM FOR COMPUTER PROGRAM

(71) Applicant: KONICA MINOLTA., INC., Tokyo (JP)

(72) Inventors: Akihiro HAYASHI, Okazaki-shi (JP); Yuji KOBAYASHI, Toyohashi-shi (JP); Harumitsu FUJIMORI, Tokyo (JP); Shiro UMEDA, Toyokawa-shi (JP); Kosuke MASUMOTO, Tokyo (JP); Yasuhiro ISHIHARA, Toyohashi-shi (JP); Hiroshi YAMAGUCHI, Toyokawa-shi (JP); Isao WATANABE, Toyohashi-shi (JP)

(73) Assignee: KONICA MINOLTA, INC., Tokyo (JP)

(21) Appl. No.: 14/746,027

(22) Filed: Jun. 22, 2015

(30) Foreign Application Priority Data
Jun. 23, 2014 (JP) 2014-128508

(51) Int. Cl. H04N 5/272; H04N 5/262; G06K 9/00

(52) U.S. Cl. CPC H04N 5/272; G06K 9/00369; G06K 9/00375; H04N 5/2621

(57) ABSTRACT

A photographing system includes a photographing device configured to photograph a surface; a detector configured to detect a change in a position of an object in a space between the surface and the photographing device; and an obtaining portion configured to obtain an image of an area of the surface by the photographing device when the detector detects the change, the area being not viewed by the photographing device before the change due to interruption of the object and being viewed by the photographing device after the change.

This application is based on Japanese patent application No. 2014-128508 filed on Jun. 23, 2014, the contents of which are hereby incorporated by reference.

### BACKGROUND OF THE INVENTION

1. Field of the Invention

The present invention relates to a technology for photographing a surface of a whiteboard, and so on.

2. Description of the Related Art

Recent years have seen the widespread use of projectors which projects, onto a screen, an image displayed in a personal computer or smartphone. Such a projector is sometimes called an “image projection device”.

The screen may be a whiteboard. The screen may be a white plastic sheet put on a wall. In such cases, a user may take a note on the screen with a pen while an image is projected onto the screen. The user may take a photo of the screen with a digital camera for recording.

There has been proposed a technology which allows a user to take a photo easily. According to the technology, a projector has a digital camera built therein, and a lens for projection to a liquid crystal projector and a lens for the digital camera are used in common. Thereby, both the projected light of the video by a personal computer outputted from the projector and the incident light of a synthetic image of the image handwritten by using a marker pen or the like on a whiteboard pass through the same lens. This eliminates, in importing the synthetic video of the video by the personal computer and the handwritten image to the personal computer, the need to adjust the position and size thereof (English abstract of Japanese Laid-open Patent Publication No. 2004-252118).

According to another technology, an imaging device has plural imaging units for achieving image data, an imaging range changing unit for individually changing at least one of an imaging direction and an imaging field angle of each of the plural imaging units to change an imaging range, a gesture detector for detecting an operator's gesture from the image data achieved by any one of the imaging units, and an imaging controller for performing control of changing an imaging range to be recorded and imaging control containing an imaging instruction to the plural imaging units in accordance with the detected gesture. When the change of the imaging range to be recorded is controlled, the imaging controller controls the imaging range changing means to change the imaging range of an imaging unit concerned as a part of the plural imaging units in accordance with the gesture detected by the gesture detector. When an operator is not contained in the imaging range of the imaging unit concerned, change of the imaging ranges of imaging units other than the imaging unit concerned is restricted to the range within which the operator is contained (English abstract of Japanese Laid-open Patent Publication No. 2012-15661).

According to yet another technology, an image processor detects a framework area of a projection image projected onto a whiteboard from a photographic image signal supplied, and determines whether or not a dynamic body enters and exits the framework area. If the dynamic body enters and exits the framework area, the processor detects a difference between images of the framework area before and after the movement of the dynamic body, obtains images of the area with the difference, and combines the obtained images with an original image to generate a combined image. This process is repeated until the original image projected by the projector is switched to a next image to generate the combined image sequentially in which the difference image and the original image are combined. At the point when the projection image is switched to the next image, the combined image is made associated with the immediately before original image in the order the images are written. Additionally, the combined images associated with the original image in the order of the images written are inserted as images of a page next to the original image (Japanese Laid-open Patent Publication No. 2012-199676).

According to the conventional technologies, an image written by a user in the surface of a whiteboard or the like can be photographed together with an image projected on the surface of the whiteboard by a projector to make a record of the images.

In order that the images are photographed reliably without hiding behind a user's body or a pointer, the user has to move away from the surface of the whiteboard or the like. The user sometimes feels stressed or gets pressured to keep him/her conscious of moving away from the surface of the whiteboard. The user forgets to move away from the surface in some cases. Even though the user thinks that he/she has moved away from the surface, he/she does not actually move away therefrom in other cases. The cases sometimes do not allow an image to be photographed properly.

### SUMMARY

The present invention has been achieved in light of such an issue, and an object thereof is to make a record of an image written in a surface more certainly and more user-friendly than is conventionally possible.

According to an aspect of the present invention, a photographing system includes a photographing device configured to photograph a surface; a detector configured to detect a change in a position of an object in a space between the surface and the photographing device; and an obtaining portion configured to obtain an image of an area of the surface by the photographing device when the detector detects the change, the area being not viewed by the photographing device before the change due to interruption of the object and being viewed by the photographing device after the change.

These and other characteristics and objects of the present invention will become more apparent by the following descriptions of preferred embodiments with reference to drawings.

### BRIEF DESCRIPTION OF THE DRAWINGS

FIG. 1 is a diagram showing an example of how a projector according to a first embodiment of the present invention is used.

FIG. 2 is a block diagram showing an example of the hardware configuration of a projector.

FIG. 3 is a diagram showing examples of an object.

FIGS. 4A-4C show examples of a positional relationship between a board surface and an object.

FIG. 5 is a block diagram showing an example of the functional configuration of a projector.

FIG. 6 is a diagram showing an example of how to set a target area to photograph a board surface.

FIG. 7 is a diagram showing a first example of photographing depending on the movement of an object.

FIG. 8 is a diagram showing a second example of photographing depending on the movement of an object.

FIG. 9 is a diagram showing a third example of photographing depending on the movement of an object.

FIG. 10 is a flowchart depicting an example of the flow of operation by a projector.

FIG. 11 is a block diagram showing an example of the functional configuration of a projector according to a second embodiment.

FIG. 12 is a diagram showing an example of how to set a tentative target area according to a second embodiment.

FIG. 13 is a diagram showing an example of reduction in a tentative target area.

FIG. 14 is a diagram showing a fourth example of photographing depending on the movement of an object.

FIG. 15 is a flowchart depicting an example of a first part of the flow of operation according to a second embodiment.

FIG. 16 is a flowchart depicting an example of a second part of the flow of operation according to a second embodiment.

FIG. 17 is a diagram showing a variation of a system configuration.

### DESCRIPTION OF THE PREFERRED EMBODIMENTS

### First Embodiment

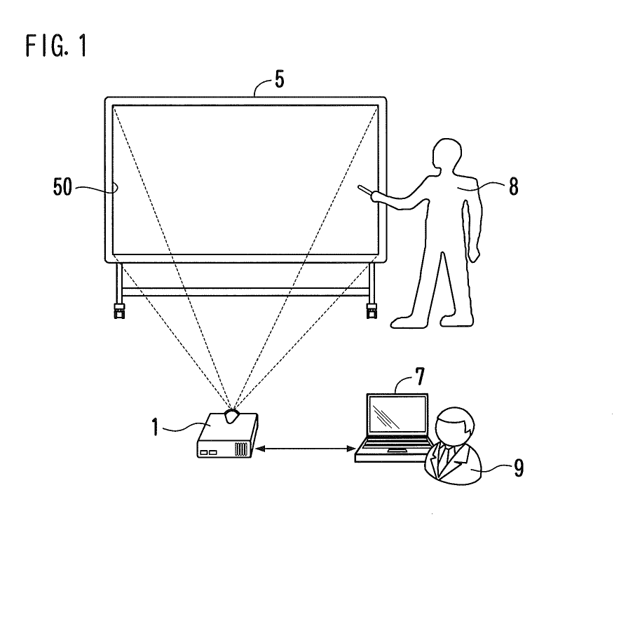

Referring to FIG. 1, a projector 1 and a whiteboard 5 are used to make a presentation. The projector 1 is connected to a personal computer 7 operated by a presenter 8 or an assistant 9. The personal computer 7 gives data on an image to be projected and a projective instruction to the projector 1. The projector 1 follows the instruction from the personal computer 7 to project an image used for presentation onto the whiteboard 5. The whiteboard 5 is used as a screen for projection.

The whiteboard 5 has a board surface 50. The presenter 8 may add supplemental information to a projected image or highlight the image by writing a character, symbol, line, arrow, circle, graphic, or any combination thereof in the board surface 50. In short, the board surface 50 is a surface in which the presenter 8 can write supplemental information. The presenter 8 can also erase the content.

The projector 1 has a photographing function to automatically record a content written by the presenter 8 in the board surface 50. The projector 1 monitors the movement of the presenter 8. When determining that writing has been made, the projector 1 photographs the whiteboard 5, and saves photographic data captured by the photographing.

The photographing function of the projector 1 according to the first embodiment is characterized by: delimiting areas of the board surface 50 (separate areas); setting at least one of the areas to a “target area” on which processing of recording a content written is performed; and photographing the board surface 50 at time of detecting a state where the target area does not hide behind an object. The description goes on to the configuration and operation of the projector 1, focusing on the photographing function.

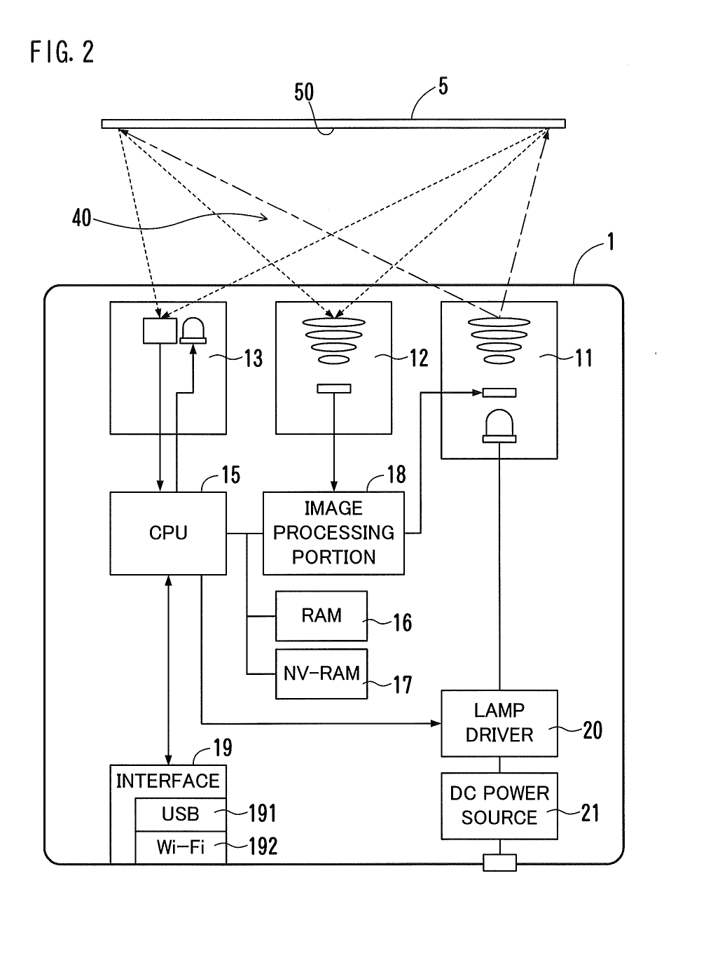

FIG. 2 shows an example of the hardware configuration of the projector 1. The projector 1 is provided with a projection unit 11, a camera 12, an object sensor 13, a Central Processing Unit (CPU) 15, a Random Access Memory (RAM) 16, a non-volatile memory 17, an image processing portion 18, an interface 19, a lamp driver 20, a Direct Current (DC) power source 21, and so on.

The projection unit 11 is a display means for displaying an image by projecting the image onto the board surface 50. The projection unit 11 includes a liquid crystal panel for displaying an image to be projected, a flood lamp provided in the back of the liquid crystal panel, and a group of lenses for forming an image on the projection surface. The DC power source 21 supplies power necessary for the flood lamp to emit light to the projection unit 11 through the lamp driver 20.

The camera 12 is a photographing means for taking an image of the board surface 50. The camera 12 has a two-dimensional image pickup device. The camera 12 outputs photographic data obtained by the image pickup device to the image processing portion 18. The camera 12 may be a scanner camera for obtaining a two-dimensional photographic image with a one-dimensional image pickup device and a scanning optical system.

The object sensor 13 is a range image sensor for detecting an object which is present between the board surface 50 and the camera 12. The object sensor 13 includes an image pickup device and a light-emitting device for emitting infrared rays. The object sensor 13 outputs, to the CPU 15, infrared photographic data for range-finding by the Time-of-Flight (TOF) method.

The CPU 15 loads a program for controlling the projector 1 from the non-volatile memory 17 into the RAM 16 to execute the program. The CPU 15 performs communication with the personal computer 7 through the interface 19 for communication with external devices. The CPU 15 controls the projector 1 to project an image in accordance with instructions from the personal computer 7. The CPU 15 also executes the variety of processing of detecting an object, of setting a target area related to photograph the board surface 50, and of storing the photographic data captured by the camera 12 into the non-volatile memory 17. The variety of processing is discussed later. The non-volatile memory 17 is, for example, a flash memory.

The image processing portion 18 expands, in a memory, a bitmapped image corresponding to the data sent by the personal computer 7 to display an image to be projected in the liquid crystal panel of the projection unit 11. The image processing portion 18 also performs processing for compressing the photographic data captured by the camera 12. The image processing portion 18 includes, for example, an Application Specific Integrated Circuit (ASIC).

The interface 19 has a USB portion 191 which enables wired communication meeting the Universal Serial Bus (USB) standards. The interface 19 also has a Wi-Fi portion 192 which enables wireless communication meeting the Wi-Fi standards.

The projector 1 according to the first embodiment photographs a content written in the board surface 50 at a time when the content is not hidden, and makes a record of the content written. This enables detection of a change in position of an object in the photographic space 40. The photographic space 40 is a part, of a space between the board surface 50 and the projector 1, within the field of view of the camera 12 for photographing. How to detect a change in position of an object is as follows.

The CPU 15 measures, for each pixel of the image pickup device, a time from when infrared rays are emitted to when the infrared rays reflected on the surface of the object are received by the image pickup device, namely, time-of-flight of light. The measurement is made based on the infrared photographic data obtained by the object sensor 13. At this time, the following measurement method is used: the infrared rays are applied to the object during a predetermined amount of time depending on a maximum distance to be measured, and the total amount of light received during the application of the infrared rays is measured as the time-of-flight of light. The time-of-flight of light is proportional to a distance between the object sensor 13 and the object. Thus, measuring the time-of-flight of light for each pixel obtains a range image corresponding to the field of view for image pickup by the object sensor 13.

The CPU 15 compares each pixel value (value of range-finding) of the obtained range image and a distance (known distance) to the whiteboard 5 stored in advance. The known distance may be measured in advance by the projector 1, or may be entered by the user. If the range image includes a predetermined number or greater of pixels having a value of range-finding smaller than the known distance, then the CPU 15 determines that an object is present within the photographic space 40. Otherwise, the CPU 15 determines that no object is present within the photographic space 40. The predetermined number is a threshold used to prevent a situation where it is erroneously determined that an object is present in spite of no object being present actually. Even if the range image contains a pixel having an erroneous value of range-finding smaller than the known distance due to ambient light or other reasons, it is determined that no object is present as long as the number of such pixels is smaller than the predetermined number.

To be exact, the object sensor 13 and the camera 12 are different from each other in field of view. The difference is, however, very slight which exerts no substantial influence on making a record of writing. Therefore, in the first embodiment, it is assumed that the field of view of the object sensor 13 corresponds to the field of view of the camera 12, and that detection of an object in the photographic space 40 is made based on the range image obtained by the object sensor 13.

If the presence of an object is detected in the photographic space 40, then the CPU 15 extracts, from the range image, a part corresponding to the object, namely, a part having a value of range-finding smaller than the forgoing known distance. The extraction identifies the size of the object and the position (three-dimensional position) of the object in the photographic space 40. For the extraction, the camera 12 or the object sensor 13 may be used to obtain a two-dimensional photographic image for image recognition, and it may be determined whether or not each pixel of the range image corresponds to the object based on the comparison result of the value of range-finding in the range image and the image recognition result of the two-dimensional photographic image.

The CPU 15 controls the object sensor 13 to operate periodically at intervals of approximately 0.5-3 seconds. Every time when controlling the object sensor 13 to operate, the CPU 15 obtains the latest infrared photographic data from the object sensor 13. Every time when obtaining the infrared photographic data from the object sensor 13, the CPU 15 determines whether or not an object is present in the photographic space 40. When determining that an object is present therein, the CPU 15 identifies the size and position of the object. The periodic identification of the object position enables detection as to whether the object enters the photographic space 40, and detection as to whether the object exits the photographic space 40, and also enables detection of change in position of the object in the photographic space 40.

The time interval for the CPU 15 to obtain the infrared photographic data from the object sensor 13 may be changed depending on the presence or absence of an object in the photographic space 40. In doing so, the CPU 15 obtains the infrared photographic data during a period from when detecting that the object is present in the photographic space 40 until when detecting thereafter that the object is not present therein, namely, during a period of the presence of the object, for example, at intervals of approximately 0.5-1 seconds. During a period other than the foregoing period, namely, during a period of the absence of the object, the CPU 15 obtains the infrared photographic data at time intervals longer than that for the case where the object is present, for example, at intervals of approximately 1-3 seconds.

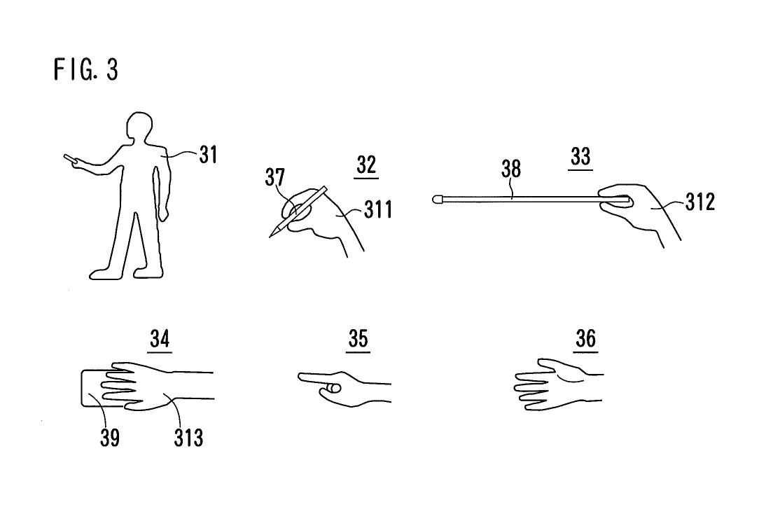

FIG. 3 shows examples of an object. While the projector 1 is used to make a presentation, what moves into and out of the photographic space 40 is mostly limited to the presenter 8. In this embodiment, examples of the object 30 are: (1) a body (entire body or upper body) 31 of the presenter 8; (2) a combination 32 of a pen 37 and a hand 311 holding the same; (3) a combination 33 of a pointer 38 and a hand 312 holding the same; (4) a combination 34 of an eraser 39 and a hand 313 holding the same; (5) a hand 35 pointing to somewhere; and (6) a flat of the hand 36.

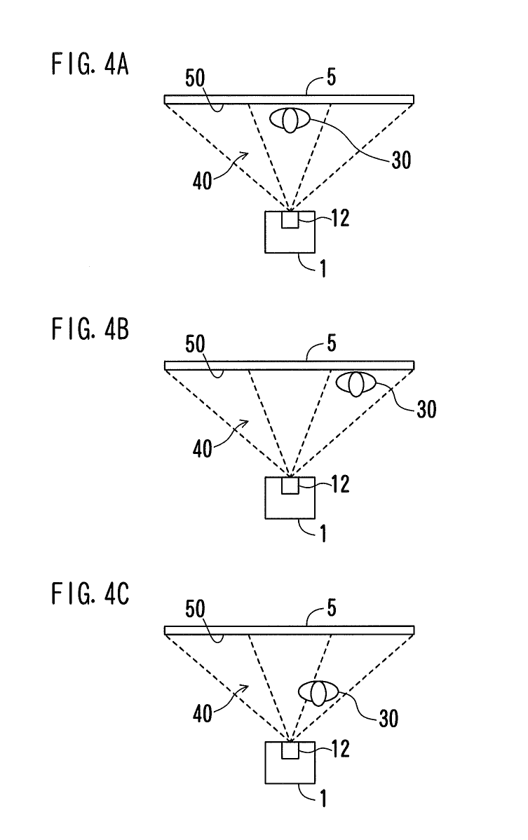

FIGS. 4A-4C show examples of a positional relationship between the board surface 50 and the object 30.

Referring to FIG. 4A, the object 30 is present close to the board surface 50 in the middle part in the right to left direction of the photographic space 40. In such a case, the middle part of the board surface 50 in the right to left direction hides behind the object 30. The phrase “a part of the board surface 50 hides behind the object 30” means that a part of the board surface 50 is not viewed by the camera 12 due to the interruption of the object 30.

Referring to FIG. 4B, the object 30 is present close to the board surface 50 in the right end of the photographic space 40. In such a case, the right end of the board surface 50 and its vicinity hide behind the object 30.

Referring to FIG. 4C, the object 30 is present close to the projector 1 on the right side within the photographic space 40. In such a case, the board surface 50 hides behind the object 30 at a relatively large part from near the right end of the board surface 50 to near the middle of the board surface 50.

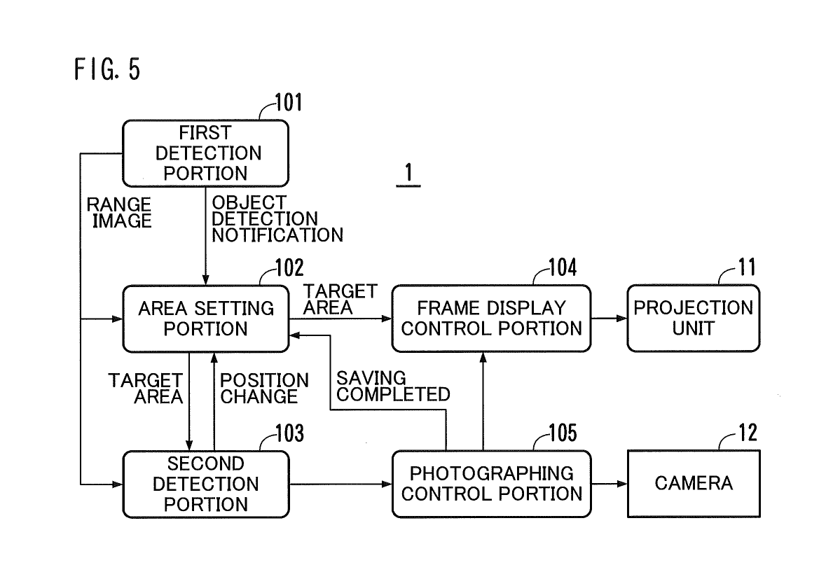

FIG. 5 shows an example of the functional configuration of the projector 1. The projector 1 is configured of a first detection portion 101, an area setting portion 102, a second detection portion 103, a frame display control portion 104, a photographing control portion 105, and so on. The portions are the functional elements implemented in response to the program executed by the CPU 15.

The first detection portion 101 is a means for detecting the object 30. The first detection portion 101 periodically obtains the latest infrared photographic data from the object sensor 13 as discussed above. Every time obtaining the infrared photographic data, the first detection portion 101 detects the presence or absence of the object 30 in the photographic space 40. The first detection portion 101 generates a range image based on the obtained infrared photographic data.

The area setting portion 102 is a means for setting the target area described earlier. When the first detection portion 101 detects that the object 30 moves into the photographic space 40, the area setting portion 102 obtains the latest range image from the first detection portion 101 to detect the size and position of the object 30. The area setting portion 102 then identifies a part of the board surface 50 which hides behind the object 30 with respect to the camera 12 based on the positional relationship of the range image, and delimits areas (separate areas) of the board surface 50 as described later depending on the size of the identified part. After that, the area setting portion 102 selects an area having a part hiding behind the object 30 from among the areas, and sets the selected area to a target area.

Further, when it is detected that a part hiding behind the object 30 changes to an area which is not the current target area, the area setting portion 102 again delimits areas of the board surface 50 to set a target area, provided that the size of the object 30 is so different from the previous size thereof as to exceed a pre-set value.

The second detection portion 103 is a means for detecting a change in position of the object 30 in the photographic space 40. After the area setting portion 102 sets the target area, every time the first detection portion 101 obtains the infrared photographic data, the second detection portion 103 obtains the latest range image from the first detection portion 101 to identify the position of the object 30. The second detection portion 103 then detects a change in position of the object 30.

Thereafter, the second detection portion 103 detects the change in position of the object 30 from a position where the object 30 hides the whole or a part of the target area from the camera 12 to a position where the object 30 does not hide the whole or a part of the target area therefrom.

The phrase “hiding the target area from the camera 12” means that the camera 12 cannot catch the entire view of the target area. Hereinafter, a state where at least a part of an area hides behind the object 30, namely, a state where a part or the entirety of an area cannot be viewed by the camera 12, is sometimes referred to as a “state where the area hides behind the object 30”.

The frame display control portion 104 is a means for controlling the projection unit 11 to display a frame. When the area setting portion 102 sets a target area, the frame display control portion 104 controls the projection unit 11 to display a red frame or a frame having another predetermined color on the board surface 50. Such a frame is a distinctive image representing the contour of the target area. The frame may have any style as long as it indicates the size and position of the target area. The frame may have brightness different from the brightness around the frame. Instead of the display of the frame, or, along with the display thereof, it is possible to make the brightness or background color of the entirety of the target area differ from that of other areas. Applying a ground design to the target area is also possible.

The photographing control portion 105 is a means for obtaining an image displayed in the target area by means of the camera 12. When the second detection portion 103 detects a change in position of the object 30 from a position where the whole or a part of the target area is hidden to a position where the whole or a part of the target area is not hidden, the photographing control portion 105 controls the camera 12 to take an image of the target area which was hidden and not viewed by the camera 12 before the change but is viewed thereby after the change. In this embodiment, the photographing control portion 105 controls the camera 12 to take an image of the entirety of the board surface 50 including the target area.

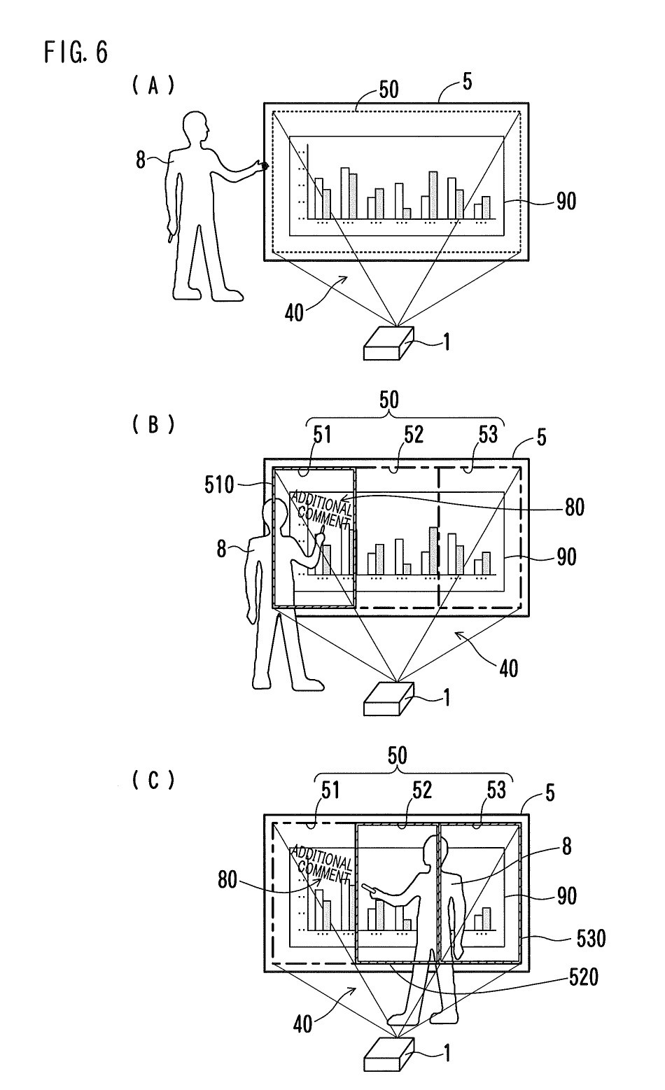

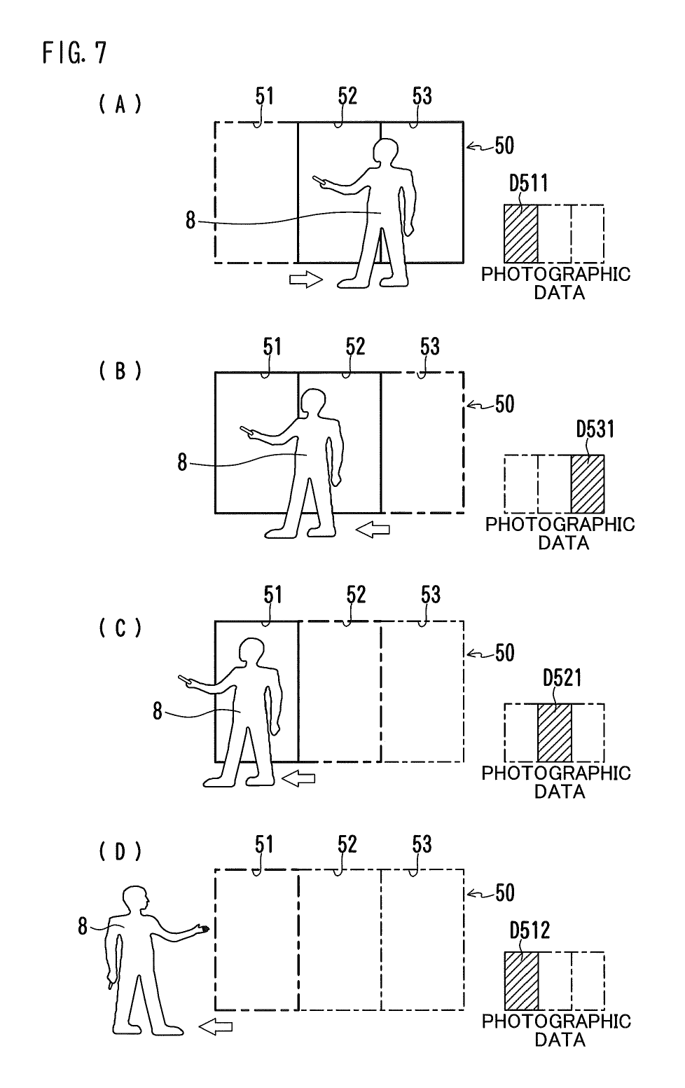

FIG. 6 shows an example of how to set a target area to photograph the board surface 50. FIG. 7 shows a first example of photographing depending on the movement of the object 30. In the illustrated examples, it is assumed that the presenter 8 writes in the whiteboard 5, and then keeps making a presentation while walking or stopping in front of the whiteboard 5. The projector 1 sets a target area in the manner discussed below depending on a change in position of the presenter 8 which is the object 30, and photographs to make a record of the content of writing in the target area.

Referring to (A) of FIG. 6, an image 90 provided by the personal computer 7 is projected onto the whiteboard 5. The illustrated image 90 is a bar graph. The presenter 8 stands close to and on the left of the whiteboard 5.

The field of view of the camera 12 is so adjusted that the photographic space 40 includes the entirety of the board surface 50 of the whiteboard 5. FIG. 6 shows an example where the photographic space 40 includes the board surface 50 appropriately. The present invention is, however, not limited to this example. The field of view of the camera 12 may be so adjusted that the photographic space 40 includes the board surface 50 in which the presenter 8 may write and the vicinity of the board surface 50. In essence, the field of view of the camera 12 is preferably adjusted so that at least the entirety of the board surface 50 is photographed.

It is assumed that the presenter 8 outside the photographic space 40 shown in (A) of FIG. 6 moves to the right, and stands in front of the left end of the board surface 50 to write in the board surface 50 as shown in (B) of FIG. 6. In the illustrated example, a character string 80 is written in the left end of the board surface 50.

While the state changes from (A) to (B) of FIG. 6, the first detection portion 101 detects the presenter 8 as the object 30 at a time when the presenter 8 moves into the photographic space 40. When receiving a notification of the detection of the object 30 from the first detection portion 101, the area setting portion 102 delimits areas 51, 52, and 53 of the board surface 50 depending on the object 30. In the example of (B) of FIG. 6, the board surface 50 is separated into the three areas 51, 52, and 53 having the same size in the right to left direction.

For delimiting areas of the board surface 50, delimitation patters are preset as choices. Data on the delimitation patters are stored in the non-volatile memory 17. The area setting portion 102 selects any of the delimitation patterns depending on the size of the object 30 to delimit areas of the board surface 50.

For the case where the vertical dimension of the object 30 is greater than a predetermined threshold (a half of the vertical dimension of the board surface 50, for example), the choices of delimitation patterns include: a delimitation pattern in which two areas extending from the upper end to the lower end of the board surface 50 are provided side-by-side; a delimitation pattern in which three areas extending from the upper end to the lower end of the board surface 50 are provided side-by-side; and a delimitation pattern in which four or more areas extending from the upper end to the lower end of the board surface 50 are provided side-by-side. When the vertical dimension of the object 30 is greater than the threshold, any of these delimitation patterns is selected depending on the horizontal dimension of the object 30. Areas of the board surface 50 are delimited in accordance with the selection result. As the horizontal dimension of the object 30 is greater, a delimitation pattern having smaller number of delimited areas in the right to left direction is selected. FIG. 6 shows, in (B), that the delimitation pattern in which three areas are provided side-by-side is selected.

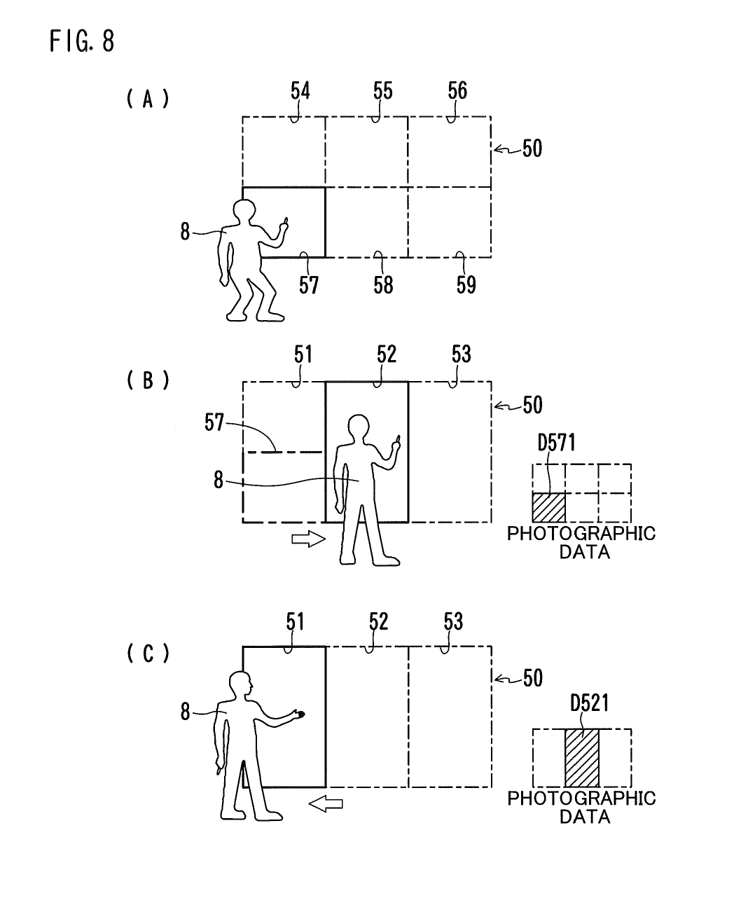

For the case where the vertical dimension of the object 30 is smaller than the predetermined threshold, the choices of delimitation patterns include: a delimitation pattern in which two areas of the board surface 50 are delimited vertically, and two areas of the board surface 50 are delimited horizontally; a delimitation pattern in which two areas of the board surface 50 are delimited vertically, and three areas of the board surface 50 are delimited horizontally; and a delimitation pattern in which two areas of the board surface 50 are delimited vertically, and four or more areas of the board surface 50 are delimited horizontally. When the vertical dimension of the object 30 is smaller than the threshold, any of these delimitation patterns is selected depending on the horizontal dimension of the object 30. Areas of the board surface 50 are delimited in accordance with the selection result. FIG. 8 shows, in (A), that the delimitation pattern in which total six areas are provided is selected.

For delimiting areas of the board surface 50, the area setting portion 102 selects a delimitation pattern having an area containing the entirety of a part hiding behind the object 30. If there is a plurality of such delimitation patterns as choices, the area setting portion 102 selects a delimitation pattern in which an area to be set as the target area is smallest. Making each area small allows the presenter 8 to move without paying attention to photographing. The entirety of a part hiding behind the object 30 fits into the target area, which minimizes the possibility of making a record of writing having a missing part.

When delimiting the areas 51, 52, and 53 of the board surface 50, the area setting portion 102 discriminates the area 51 hiding behind the object 30 from the areas 52, and 53. The area setting portion 102 then sets the area 51 thus discriminated to a target area. In the first embodiment, the target area is an area including a part of the board surface 50 which has hidden behind the object 30. The target area probably has had writing when the target area has hidden behind the object 30. As for (B) of FIG. 6, of the three areas 51, 52, and 53 provided side-by-side, the left area 51 is set to the target area.

When the area setting portion 102 sets the target area, the frame display control portion 104 controls the projection unit 11 to display a frame 510 representing the contour of the target area. The projection unit 11 leaves the image 90 displayed, and further displays the frame 510 by using a projection technique of overlapping a layer in which the image 90 is drawn and a layer in which the frame 510 is drawn.

The display of the frame 510 enables the presenter 8 to know in which area of the board surface 50 a written content is to be recorded.

Another configuration is possible in which a mode of displaying the frame 510 and a mode of not displaying the frame 510 are prepared to enable a user of the projector 1 to select one of the modes. If the latter mode is selected, the frame display control portion 104 does not control the projection unit 11 to display the frame 510.

It is assumed that the presenter 8 standing in front of the left end of the board surface 50 as shown in (B) of FIG. 6 moves to the right, and stands at a position where the whole or a part of the areas 52 and 53 of the board surface 50 hides behind the presenter 8 as shown in (C) of FIG. 6.

While the state changes from (B) to (C) of FIG. 6, the second detection portion 103 detects a change in position of the presenter 8 as the object 30 at a time when the presenter 8 moves to a position where the area 51 as the target area at that time does not behind the presenter 8, in other words, at a time when the presenter 8 moves out of a target area space which is a part of the photographic space 40 and into which the target area fits. At this time, the photographing control portion 105 controls the camera 12 to take an image of the board surface 50.

In the first embodiment, the camera 12 takes an image of the entirety of the board surface 50, and a part corresponding to the target area of the obtained photographic data is saved to the non-volatile memory 17. The present invention is not limited to this example. Photographing the target area of the board surface 50 selectively is also possible.

For saving the photographic data, identification information on the image 90 currently displayed is added to the photographic data to be saved, so as to show the image displayed at a time when the board surface 50 is photographed. Further, positional information on the target area is added to the photographic data to be saved, so as to show which part of the board surface 50 the photographic data corresponds to. Moreover, in photographing a plurality of times during one image 90 displayed, information for identifying the photographic order or photographic time is also added to the photographic data to be saved, so as to show, the photographic order.

The photographing control portion 105 controls the image processing portion 18 to extract a part corresponding to the target area from the photographic data obtained by the camera 12 to compress the resultant. The photographing control portion 105 adds, to the post-compression photographic data, the identification information on the image 90 and so on to store the resultant into the non-volatile memory 17.

As discussed above, when the board surface 50 is photographed in order to make a record of what is written in the area 51, the area setting portion 102 cancels the setting in which the area 51 is the target area.

Referring to (C) of FIG. 6, the presenter 8 stands at a position where the two areas 52 and 53 partly hide behind the presenter 8. If the presenter 8 moves remaining standing to the position shown in (C) of FIG. 6, the size of the object 30 detected by the area setting portion 102 is not substantially different from that detected in the state of (B) of FIG. 6. For this reason, whether or not each of the areas 51, 52, and 53 hides behind the object 30 is determined with the three areas 51, 52, and 53 of the board surface 50 remaining delimited.

At a time when the presenter 8 moves to a position where the whole or a part of the area 52 hides behind the presenter 8, the area setting portion 102 determines that the area 52 is an area hiding behind the object 30. The area setting portion 102 then sets the area 52 to a target area. In response to this operation, the frame display control portion 104 controls the projection unit 11 to display a frame 520 representing the contour of the area 52 which is the target area.

At a time when the presenter 8 moves to a position where the whole or a part of the area 53 hides behind the presenter 8, the area setting portion 102 determines that the area 53 is an area hiding behind the object 30. The area setting portion 102 then sets the area 53 to a target area. In response to this operation, the frame display control portion 104 controls the projection unit 11 to display a frame 530 representing the contour of the area 53 which is the target area.

Since the state where the whole or a part of the area 52 hides behind the presenter 8 still continues even after the presenter 8 moves to the position where the area 53 hides behind the presenter 8, the settings in which the area 52 is set to the target area are not cancelled. In view of this, both the areas 52 and 53 are target areas in

(C) of FIG. 6, which is expressed by projecting the frames 520 and 530.

FIG. 7 shows, in (A), a simplified version of the state of (C) of FIG. 6. The presenter 8 who has written in the area 51 stands at a position where both the area 52 and the area 53 partly hide behind the presenter 8. In the example of (A) of FIG. 7, both the areas 52 and 53 are set to target areas.

Prior to the state of (A) of FIG. 7, the presenter 8 who has written in the area 51 moves to a position at which the area 51 does not hide behind the presenter 8. At this time, the board surface 50 is photographed to make a record of the content written, and photographic data D511 on the area 51 is saved.

It is assumed that the presenter 8 moves to the left and the state thereby changes from (A) to (B) of FIG. 7. Referring to (B) of FIG. 7, the presenter 8 stands in front of the board surface 50 so that both the area 51 and the area 52 are partly hidden.

The movement of the presenter 8 from the state of (A) of FIG. 7 to the left causes the area 53 which has been the target area in (A) of FIG. 7 to be not hidden by the presenter 8. At this time, the board surface 50 is photographed, and photographic data D531 on the area 53 is saved.

In (B) of FIG. 7, the whole or a part of the area 51 and the whole or a part of the area 52 hide behind the presenter 8, and both the areas 51 and 52 are set to target areas. Further, the settings in which the area 53 is set to the target area are cancelled.

It is assumed that the presenter 8 further moves to the left and the state thereby changes from (B) to (C) of FIG. 7. Referring to (C) of FIG. 7, the presenter 8 stands in front of the left end of the board surface 50 so that the whole or a part of the area 51 hides behind the presenter 8.

The movement of the presenter 8 from the state of (B) of FIG. 7 to the left causes the area 52 which has been the target area in (B) of FIG. 7 to be not hidden by the presenter 8. At this time, the board surface 50 is photographed, and photographic data D521 on the area 52 is saved. In the example of (C) of FIG. 7, the area 51 is set to the target area, and the settings in which the area 52 is set to the target area are cancelled.

It is assumed that the presenter 8 further moves to the left and the state thereby changes from (C) to (D) of FIG. 7. Referring to (D) of FIG. 7, the presenter 8 stands close to and on the left side of the board surface 50. The board surface 50 does not hide behind the presenter 8.

The movement of the presenter 8 from the state of (C) of FIG. 7 to the left causes the area 51 which has been the target area in (C) of FIG. 7 to be not hidden by the presenter 8. At this time, the board surface 50 is photographed, and photographic data D512 on the area 51 is saved. In the example of (D) of FIG. 7, the settings in which the area 51 is set to the target area are cancelled.

FIG. 8 shows a second example of photographing depending on the movement of the object 30. In the illustrated example, it is assumed that the presenter 8, who stands on the left side of the board surface 50 as shown in (A) of FIG. 6, stoops and writes in the lower left corner of the board surface 50, then stands up, slightly moves to the right, and moves to the left while standing.

Referring to (A) of FIG. 8, the whole or a part of the lower left corner of the board surface 50 hides behind the stooping presenter 8. It is assumed that, prior to the state of (A) of FIG. 8, the presenter 8 already stoops at a time when the presenter 8 moves into the photographic space 40. Stated differently, it is assumed that, when the first detection portion 101 detects the object 30 and the area setting portion 102 delimits areas of the board surface 50, the vertical dimension of the object 30 is smaller than a predetermined threshold. In such a case, the area setting portion 102 separates the board surface 50, for example, into six areas 54, 55, 56, 57, 58, and 59 arranged in two rows and three columns as shown in (A) of FIG. 8.

Referring to (A) of FIG. 8, of the six areas 54-59, the area 57 which entirely or partly hides behind the presenter 8 is set to a target area.

It is assumed that the presenter 8 stands up and moves to the right and the state thereby changes from (A) to (B) of FIG. 8. Referring to (B) of FIG. 8, the presenter 8 stands in front of the middle of the board surface 50.

The movement of the presenter 8 from the state of (A) of FIG. 8 to the right causes the area 57 which has been the target area in (A) of FIG. 8 to be not hidden by the presenter 8. At this time, the board surface 50 is photographed, and photographic data D571 on the area 57 is saved.

In the movement of the presenter 8 from the state of (A) of FIG. 8 to the right, the presenter 8 stands up as shown in (B) of FIG. 8. This increases the size of the object 30 related to delimitation of areas of the board surface 50. The area setting portion 102 detects the increase in size of the object 30 to delimit areas of the board surface 50 again. As with the examples of FIGS. 6 and 7, the board surface 50 is separated into the three areas 51, 52, and 53 as shown in (B) of FIG. 8. The middle area 52 is set to a target area, and the settings in which the area 57 is set to the target area are cancelled.

It is assumed that the presenter 8 moves to the left while standing and the state thereby changes from (B) to (C) of FIG. 8. Referring to (C) of FIG. 8, the presenter 8 stands in front of the left end of the board surface 50.

The movement of the presenter 8 from the state of (B) of FIG. 8 to the left causes the area 52 which has been the target area in (B) of FIG. 8 to be not hidden by the presenter 8. At this time, the board surface 50 is photographed, and the photographic data D521 on the area 52 is saved. The settings in which the area 52 is set to the target area are cancelled, and the area 51 which entirely or partly hides behind the presenter 8 is set to a target area.

Although not shown, after that, the board surface 50 is photographed at a time when the area 51 does not hide behind the presenter 8, and photographic data on the area 51 is saved.

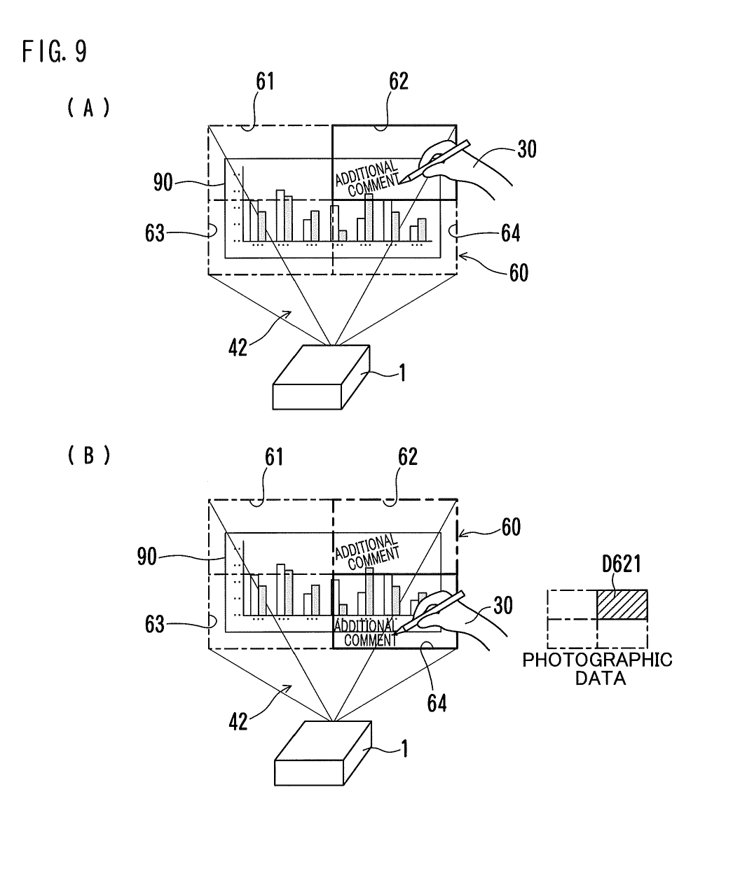

FIG. 9 shows a third example of photographing depending on the movement of an object. In the illustrated example, it is assumed that the projector 1 projects an image 90 onto a paper surface 60 of blank paper placed on a desk or put on a wall.

Referring to (A) of FIG. 9, a user of the projector 1 writes in the upper light part of the paper surface 60 onto which the image 90 is projected. The combination 32 of a pen and a hand holding the same, which is the object, is present to hide the whole or a part of the paper surface 60 from the projector 1.

As with the first and second examples, the first detection portion 101 detects the presence of the object 30 within a photographic space 42. The photographic space 42 is between the camera 12 of the projector 1 and the paper surface 60. When receiving a notification that the object 30 is present from the first detection portion 101, the area setting portion 102 delimits areas of the paper surface 60 for target area setting. Referring to (A) of FIG. 9, the paper surface 60 is separated into four areas 61, 62, 63, and 64 having the same size in two rows and two columns. Of the four areas 61, 62, 63, and 64, the area 62 which entirely or partly hides behind the object 30 is set to the target area.

It is assumed that the user moves his/her hand downward and the state thereby changes from (A) to (B) of FIG. 9. Referring to (B) of FIG. 9, the user writes in the lower right part of the paper surface 60, and the whole or a part of the paper surface 60 hides behind the object 30. In the state of (B) of FIG. 9, the area 64 is set to the target area.

The movement of the user's hand from the state of (A) of FIG. 9 to downward causes the area 62 which has been the target area in (A) of FIG. 9 to be not hidden by the object 30. When the second detection portion 103 detects such a change in position of the object 30 related to the change in state, the photographing control portion 105 controls the camera 12 to take an image of the paper surface 60. The photographing control portion 105 then stores, into the non-volatile memory 17, photographic data D621 which is a part of the photographic data on the paper surface 60 and corresponds to the area 62 of the paper surface 60. Thereby, the settings in which the area 62 for which recording writing is finished is set to the target area are cancelled.

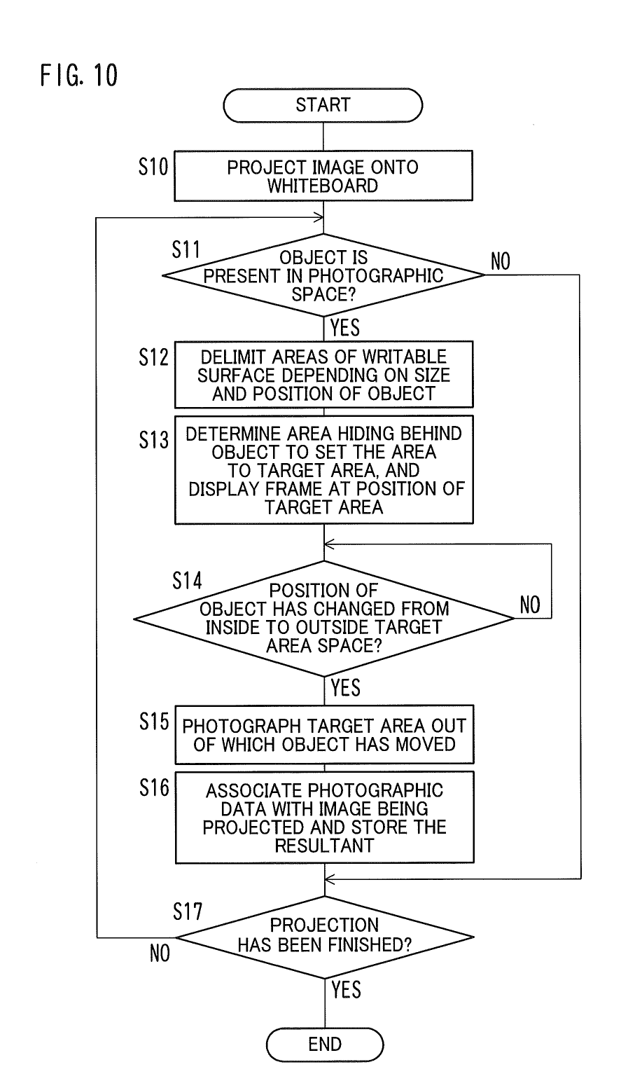

The flow of the processing by the projector 1 according to the first embodiment is summarized with reference to the flowchart of FIG. 10. The flowchart exemplifies the case where the whiteboard 5 is used as a screen for projection.

The projector 1 projects the image 90 provided by the personal computer 7 onto the whiteboard 5 in accordance with instructions from the personal computer 7 (Step S10).

If the first detection portion 101 detects the presence of the object 30 in the photographic space 40 (YES in Step S11), then the area setting portion 102 delimits areas (separate areas) 51-53 or 54-59 of the board surface 50 depending on the size of the object 30 (Step S12). The area setting portion 102 also discriminates an area which entirely or partly hides behind the object 30 from the other areas, and sets the area discriminated to a target area related to saving of photographic data. The frame display control portion 104 controls the projection unit 11 to display the frame 510, 520, or 530 each of which represents the position of the target area (Step S13).

If the second detection portion 103 detects a change in position of the object 30 from inside to outside a target area space which is a part of the photographic space 40 and corresponds to a part between the camera 12 and the target area (YES in Step S14), then the photographing control portion 105 controls the camera 12 to photograph the board surface 50 (Step S15). The photographing control portion 105 then stores, into the non-volatile memory 17, data which is a part of the photographic data obtained by the camera 12 and corresponds to the target area (Step S16). At this time, as processing for associating the photographic data with the image 90 to save the resultant, for example, identification information on the image 90 is added to the photographic data.

Projection of the image 90 continues until the personal computer 7 gives instructions to switch between images or to finish emitting the light. The projector 1 checks whether or not the projection of the image 90 is finished (Step S17). If the projection of the image 90 has not yet been finished (NO in Step S17), then the processing goes back to Step S11, and processing for making a record of the content of writing made while the image 90 is displayed continues (Step S11-Step S17). If the projection of the image 90 is finished (YES in Step S17), then the projector 1 finishes the operation shown in FIG. 9.

If the projection of the image 90 is finished in accordance with the instructions to switch between images, then the processing of Step S10-Step S17 is performed again to make a record of the content of writing made while an image replaced with the image 90 is displayed.

As discussed above, in the first embodiment, each of the areas 51-59 or the areas 61-64 obtained by separating the board surface 50 or the paper surface 60 is set at a unit used for recording what is written. Thereby, it is possible to set a time when photographing is so carried out as not to contain the object 30 in the photographic image to be recorded to a time when the object 30 moves to a position where a part of interest of the board surface 50 or the paper surface 60 does not hide behind the object 30. In contrast, when the entirety of the board surface 50 is set as a unit used for recording what is written, photographing is not started until a time at which the object 30 moves to a position where a part of interest of the board surface 50 or the paper surface 60 does not hide behind the object 30.

In comparison with an arrangement where the entirety of the board surface 50 or the entirety of the paper surface 60 is set as a unit used for recording what is written, the first embodiment produces the following advantageous effects (1) and (2).

(1) In using the system for making a presentation, in order to cause the projector 1 to make a record of what is written, all the presenter 8 has to do is to move away from an area in which the presenter 8 writes, and he/she does not have to step away from the entire board surface 50. Therefore, a distance of movement (step-away) to be made after writing is generally short, although depending on which position of the board surface 50 the presenter 8 has written in. In particular, if the presenter 8 writes pretty often, the movement at each writing is bothersome and burdensome to the presenter 8. The reduction in movement distance reduces such a workload put on the presenter 8.

Likewise, when a user of the projector 1 writes in the paper surface 60, all he/she has to do after the writing is to move his/her hand with a writing material to a position at which the target area is not hidden, so that what is written can be recorded. Stated differently, the user does not have to move his/her hand to a position at which the paper surface 60 does not hide behind the hand. The reduction in movement distance of the hand reduces a workload put on the user.

(2) In using the system for making a presentation, even when the presenter 8 continues the presentation without paying attention to his/her movement after he/she writes, it is possible to reduce failures to make a record of writing. To be specific, during the presentation, the presenter 8 normally does not stay in front of the board surface 50, and usually changes his/her position or moves his/her hand holding a pen in order to show audiences an area in which the presenter 8 writes. As long as the presenter 8 moves normally in this manner, a state in which nothing hides the area in which the presenter 8 writes occurs spontaneously, and photographing for making a record of the writing is carried out automatically.

In contrast, in the arrangement where the entirety of the board surface 50 is set as a unit used for recording what is written, if the presenter 8 who has written in the board surface 50 switches between images or finishes the presentation without moving out of the photographic space 40, none of what is written is recorded irrespective of a position of the board surface 50 in which the presenter 8 has written. According to the first embodiment, photographing is carried out as long as the presenter 8 only moves to a position at which an area having the writing does not hide behind the presenter 8. Therefore, as compared with the arrangement where the entirety of the board surface 50 is set as a unit used for recording what is written, a situation where none of writing made during the display of the image 90 is recorded is less likely to occur.

The same applies to the case where the user writes in the paper surface 60. Even when the user behaves normally without paying attention to the movement of his/her hand after he/she writes therein, a failure to make a record of writing is less likely to occur.

In the first embodiment, the aspect of delimiting areas of the board surface 50 or the paper surface 60 is not limited to the foregoing arrangement of selecting one of the choices of delimitation patterns depending on the size of the object 30 to delimit areas of the board surface 50 or the paper surface 60. Instead of the arrangement, one delimitation pattern may be always used. Alternatively, the following arrangement is also possible. A plurality of delimitation patterns is stored. In accordance with a mode selected by the user, any one of the delimitation patterns is applied to delimit areas of the board surface 50 or the paper surface 60. For example, a first mode suitable for presentation and a second mode suitable for business negotiation are provided. When the first mode is selected, a delimitation pattern is applied to delimit vertically-elongated areas 51-53 of the board surface 50 as shown in FIG. 6 where the body 31 is exemplified as the object 30. When the second mode is selected, a delimitation pattern is applied to delimit areas 61-64 of the paper surface 60 as shown in FIG. 9 where a hand with a writing material is exemplified as the object 30.

Both the case where the delimitation patterns are changed depending on the size of the object 30 and the case where one delimitation pattern is always used, the delimitation patterns are not limited to the example of FIG. 6, 8, or 9 where the board surface 50 or the paper surface 60 is separated in a matrix of 1×3, 2×3, or 2×2. The board surface 50 or the paper surface 60 may be separated in any matrix of such as a matrix of 1×2, 1×4, 2×4, 3×1, 3×2, or 3×3. It is not always necessary to separate the board surface 50 or the paper surface 60 into areas having the same size. For example, the board surface 50 or the paper surface 60 may be separated into a minimum quadrangle area containing a part which entirely or partly hides behind the object 30 and a predetermined margin around the part, and an area other than the minimum quadrangle area. The individual areas have any shape of, e.g., polygonal shape except quadrangular shape or indefinite shape as long as a set of all the areas covers the entirety of the board surface 50 or the entirety of the paper surface 60.

### Second Embodiment

In the first embodiment, a target area which is a part of the board surface 50 and of which photographic data is to be saved is set without detection as to whether or not writing is actually made in the board surface 50. In contrast, according to the second embodiment, when a projector is used to project an image onto the whiteboard 5 as with the example shown in FIG. 1, the projector detects an area, of the board surface 50, in which writing is actually made. Then, the detected area is widen by predetermined amount and the resultant area is set to a target area.

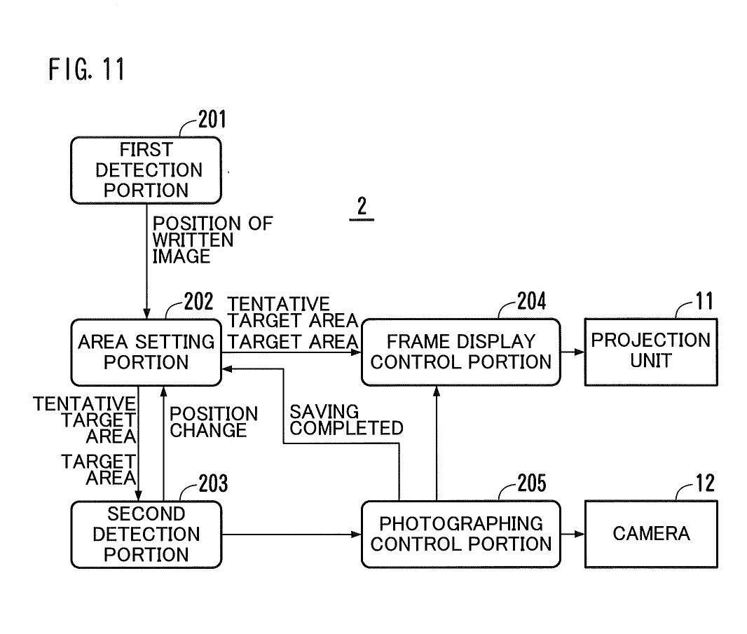

FIG. 11 shows an example of the functional configuration of a projector 2 according to the second embodiment. As with the projector 1 of the first embodiment, the projector 2 has the hardware configuration as that shown in FIG. 2. The projector 2 is configured of a first detection portion 201, an area setting portion 202, a second detection portion 203, a frame display control portion 204, a photographing control portion 205, and so on. The portions are the functional elements implemented in response to the program executed by the CPU 15 (see FIG. 2).

The first detection portion 201 is a means for detecting a part at which writing is made in the board surface 50. While writing is being made in the board surface 50, the first detection portion 201 detects a part at which a color material is added due to the writing. Hereinafter, such a part is referred to as a “written image”. Such a written image is detected, for example, in the following manner.

The first detection portion 201 controls the object sensor 13 to operate at intervals of approximately 1-3 seconds, for example. Every time when controlling the object sensor 13 to operate, the first detection portion 201 obtains infrared rays image pickup data from the object sensor 13 to generate a range image. The first detection portion 201 detects an object 30 approaching the board surface 50 based on the range image. When detecting the object 30, the first detection portion 201 controls the camera 12 to take an image of the board surface 50 at constant intervals shorter than those for the case before the detection of the object 30, for example, at intervals of approximately 0.5-1 seconds. The first detection portion 201 then compares the first photographic image and the latest photographic image to extract, from the latest photographic image, a part having a pixel value different from that of the first photographic image. Such a part is called a “different part” herein. At this time, a region to be compared is narrowed down to a part around the object 30. This leads to efficient extraction of the different part. When the object 30 writes in a part of the board surface 50 and then writes in another part away from the former part by a certain distance or more, the first detection portion 201 can extract a different part for the former writing and a difference for the latter writing.

The photographic image contains the object 30. In view of this, the first detection portion 201 identifies an image of the object 30 contained in the different part by analyzing the range image or recognizing the photographic image. The first detection portion 201 then detects, as a written image, the remaining part obtained by removing the image of the object 30 from the different part.

Another configuration is possible in which the first detection portion 201 controls the image processing portion 18 to perform image processing of, for example, different part extraction, identification of an image of the object 30, and deletion of an image of the object 30 from the different part, and thereby, the first detection portion 201 detects the written image.

The surface area of the written image increases as more writing is made. For example, when the user writes a character string, the surface area of the written image increases as the number of characters written increases. The surface area of the written image is reduced as a part of the written image is erased. If the entirety of the written image is erased, the surface area of the written image is reduced to zero. In this way, the surface area of the written image changes depending on operation of the user.

The first detection portion 201 detects the written image periodically. The first detection portion 201 then appropriately informs the area setting portion 202 of the detection result showing the position of the written image detected in the board surface 50.

The area setting portion 202 is a means for setting a target area in the board surface 50. The target area is a target on which processing of saving the photographic data is performed. In order to make a record of the written image detected by the first detection portion 201, the area setting portion 202 cooperates with the second detection portion 203 to set the target area. How to set the target area is as follows.

When receiving the detection result for the first time from the first detection portion 201, the area setting portion 202 sets a tentative target area corresponding to the written image. The tentative target area is a rectangular area which corresponds to an area obtained by expanding, in four directions (vertically and horizontally), a minimum rectangular area containing the written image (in other words, the written image is inscribed in the contour of the minimum rectangular area) by a predetermined expansion amount. The expansion amount in each of the four directions is set to, for example, approximately 5-20% of the dimension (the number of pixels) of the written image. It is preferable to set the expansion amount of a part corresponding to the part, of the written image, contacting the image of the object, to be larger than the expansion amount of another part. This is because the whole or a part of the written content possibly hides behind the object.

Until being notified that the object 30 moves out of a tentative target area space from the second detection portion 203, the area setting portion 202 updates the tentative target area in response to the receipt of the second detection result and onward from the first detection portion 101. The “tentative target area space” is a part, of the photographic space 40, between the camera 12 and the tentative target area. When being notified that the object 30 moves out of the tentative target area space from the second detection portion 203, the area setting portion 202 sets the tentative target area at this point in time to the target area.

Thereafter, during a period after the target area is set until a predetermined standby time elapses, if being notified that the object 30 moves into the tentative target area space from the second detection portion 203, then the area setting portion 202 cancels the setting of the tentative target area as the target area. In other words, the target area is returned to the tentative target area. In such a case, the area setting portion 202 updates the tentative target area in accordance with the next detection result from the first detection portion 201.

To be specific, when the object 30 moves into/out of the target area space at intervals shorter than a predetermined standby time (time within 1-5 seconds, for example), writing is being made. In such a case, the target area is not determined before the standby time elapses. The projector 2 is so controlled that the tentative target area and the target area are switched between each other depending on the movement of the object 30.

The second detection portion 203 is a means for detecting a change in position of the object 30 in the photographic space 40. After the area setting portion 202 sets the tentative target area, the second detection portion 203 locates the object 30 periodically. The interval is set to be the same as that for detection of a written image by the first detection portion 201, for example. The interval is, however, not limited thereto, and may be shorter or longer than that for detection of a written image.

Every time finding the position of the object 30, the second detection portion 203 compares the current position and the previous position. Thereby, the second detection portion 203 detects the object 30 moving out of the tentative target area space, and detects the object 30 moving into the target area space. The detection results are then notified to the area setting portion 202.

The fact that the object 30 moves out of the tentative target area space corresponds to a state in which the tentative target area does not hide behind the object 30. The fact that the object 30 moves into the target area space corresponds to a state in which the whole or a part of the target area hides behind the object 30. The target area space is a part, of the photographic space 40, between the camera 12 and the target area.

The frame display control portion 204 is a means for controlling the projection unit 11 to display a frame. When the area setting portion 202 sets a tentative target area, the frame display control portion 204 controls the projection unit 11 to display, in the board surface 50, a frame having a first color (red, for example) representing the contour of the tentative target area. When the area setting portion 202 sets a target area, the frame display control portion 204 controls the projection unit 11 to display, instead of the frame having the first color, a frame having a second color (blue, for example) representing the contour of the target area in the board surface 50.

The photographing control portion 205 is a means for controlling the camera 12 to take an image displayed in the target area. The photographing control portion 205 controls the camera 12 to take an image of the board surface 50 when the foregoing standby time has elapsed since the area setting portion 202 set the target area.

Through the display of the frame with the first color, the presenter 8 knows a written image to be recorded by photographing later. Through the display of the frame with the second color, the presenter 8 knows a written image to be about to be recorded.

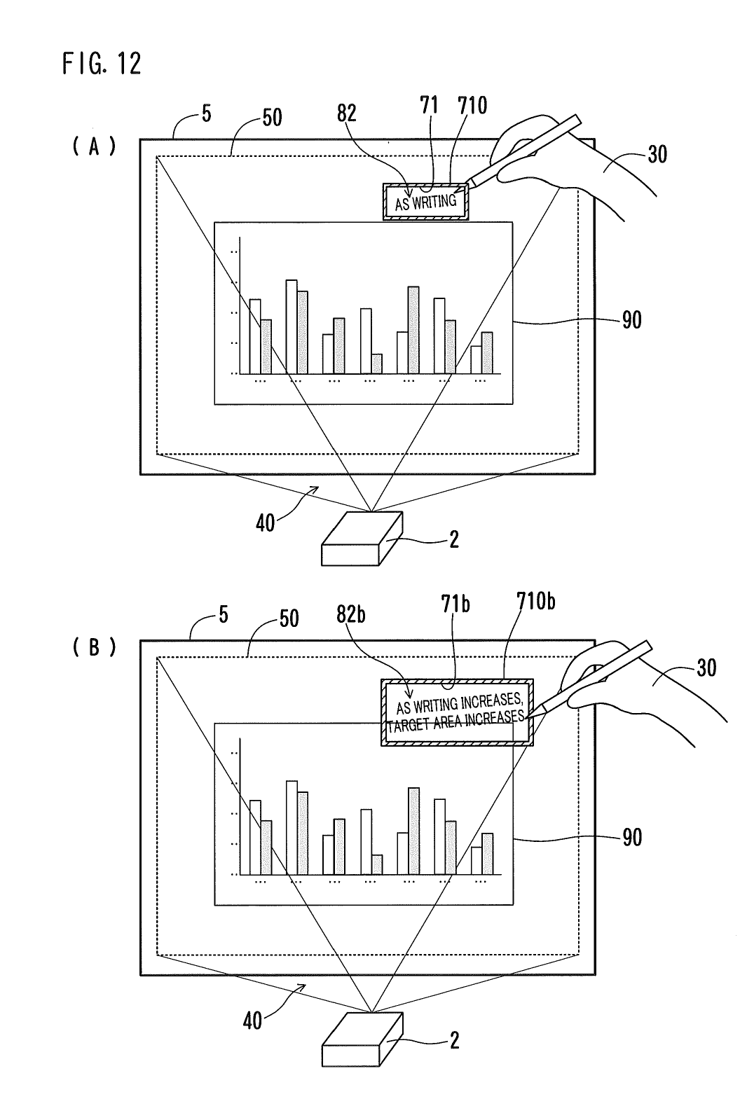

FIG. 12 shows an example of how to set a tentative target area by means of the projector 2. FIG. 12 shows, in (A) and (B), a state in which the user is writing in the whiteboard 5. In the illustrated example, the field of view of the camera 12 of the projector 2 is so adjusted that the entirety of the board surface 50 in which writing can be made fits into the photographic space 40.

Referring to (A) of FIG. 12, a character string 82 is already written in the board surface 50 onto which the image 90 is projected. The board surface 50 partly hides behind the object 30 which is a combination of a pen and a hand holding the same.

The first detection portion 201 detects the character string 82 as a written image. The area setting portion 202 sets a rectangular tentative target area 71 containing the character string 82. The projector 2 projects a frame 710 representing the size and position of the tentative target area 71.

Referring to (B) of FIG. 12, a character string 82b including the character string 82 shown in (A) of FIG. 12 and an additional written part is written in the board surface 50. The first detection portion 201 detects, as the written image, a character string 82b extending in a part larger than that of the character string 82. The area setting portion 202 sets a tentative target area 71b containing the character string 82b. A frame 710b representing the size and position of the tentative target area 71b is projected.

As seen from the comparison between (A) and (B) of FIG. 12, when the amount of what is written increases, the tentative target area 71 before the increase is updated with the tentative target area 71b larger than the tentative target area 71.

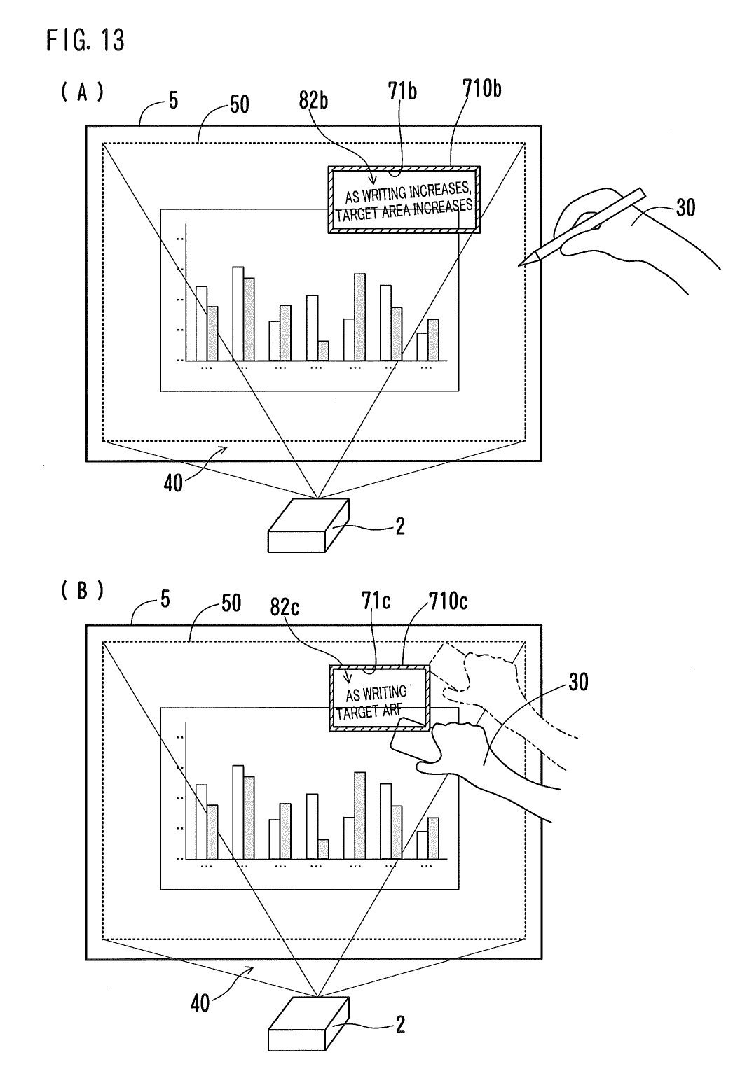

FIG. 13 shows an example of reduction in a tentative target area.

FIG. 13 shows, in (A), a state in which the user writes the character string 82b, stops writing once, and moves his/her arm to the right. The tentative target area 71b still remains set, and the frame 710b is projected. The object 30 is present on the right side of the tentative target area 71b, and the almost entirety of the object 30 is outside the photographic space 40.

FIG. 13 shows, in (B), a state in which the user is erasing a part of the character string 82b. An object 30 which is a combination of an eraser and a hand holding the same is present in front of the upper right half of the board surface 50.

In the illustrated example, a right end part of the character string 82b is already erased, and a character string 82c still remains. The first detection portion 201 detects the remaining character string 82c as a written image. The area setting portion 202 sets a tentative target area 71c containing the character string 82c. A frame 710c representing the size and position of the tentative target area 71c is projected.

As seen from the comparison between (A) and (B) of FIG. 13, when the amount of what is written reduces, the tentative target area 71b before the reduction is updated with the tentative target area 71c smaller than the tentative target area 71b.

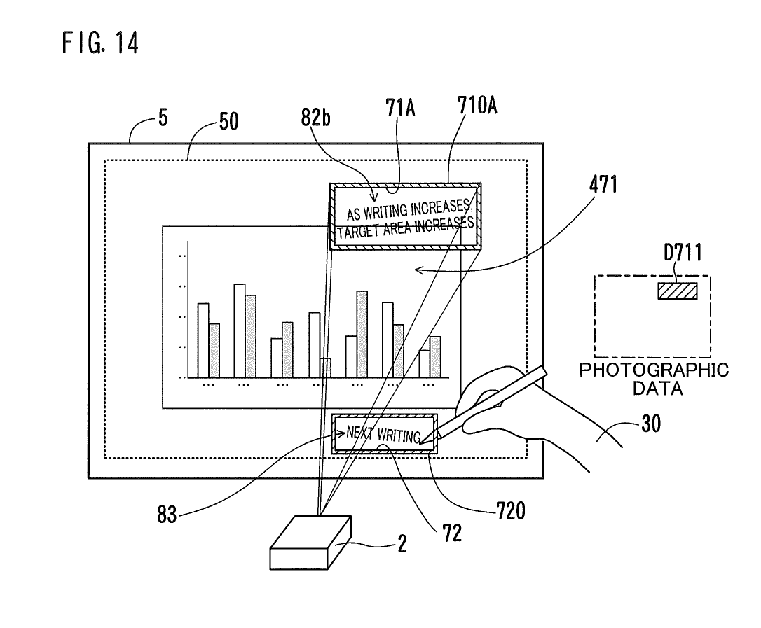

FIG. 14 shows an example of photographing the board surface 50 by the projector 2. In the illustrated example, the user writes the character string 82b in the upper right part of the board surface 50, and after that, writes in the lower right of the board surface 50.

In the illustrated example, a target area 71A containing the character string 82b is already set, and a frame 710A representing the target area 71A is projected. Further, a character string 83 is written in the lower right part of the board surface 50. A tentative target area 72 containing the character string 83 is set. A frame 720 corresponding to the tentative target area 72 is projected. The object 30 contacts the tentative target area 72, and is outside a target area space 471 between the camera 12 and the target area 71A.

After the target area 71A is set, when a state in which the object 30 is outside the target area space 471 continues for the foregoing standby time, the camera 12 of the projector 2 takes an image of the board surface 50. As with the first embodiment, photographic data D711 on the target area 71A is saved to the non-volatile memory 17. The photographic data D711 is data obtained through image clipping of extracting, from the photographic data on the board surface 50, a part containing the target area 71A.

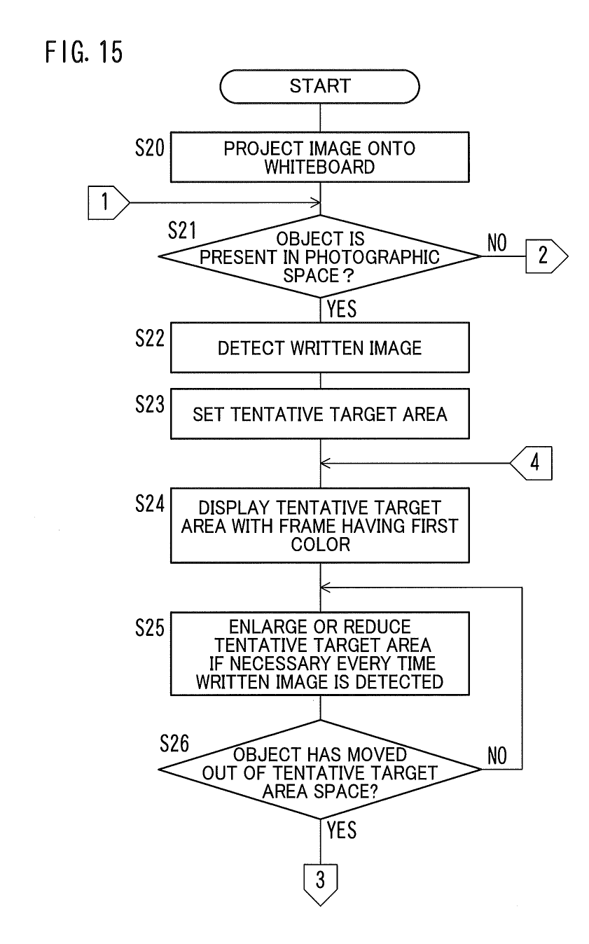

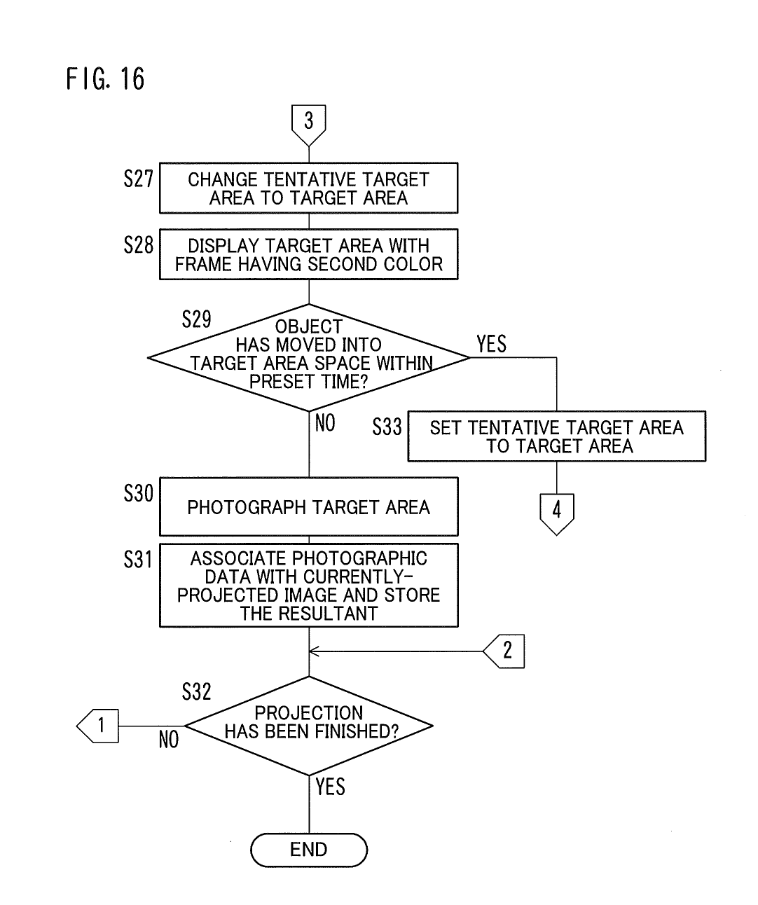

The flow of the processing by the projector 2 according to the second embodiment is summarized with reference to the flowcharts of FIGS. 15 and 16.

The projector 2 projects the image 90 provided by the personal computer 7 (see FIG. 1) onto the whiteboard 5 in accordance with instructions from the personal computer 7 (Step S20 of FIG. 15).

If the object 30 is present in the photographic space 40 (YES in Step S21), then the first detection portion 201 performs the foregoing processing for detecting a written image (Step S22). To be specific, from a time at which it is detected that the object 30 moves into the photographic space 40, the first detection portion 201 performs the processing periodically. When no writing is made, no written image is detected in Step S22. When detecting a written image, the first detection portion 201 informs the area setting portion 202 of the position of the written image.

When the first detection portion 201 informs the area setting portion 202 of the position of a written image which has not been detected previously, the area setting portion 202 sets a tentative target area containing the written image (Step S23). The frame display control portion 204 controls the projection unit 11 to project a frame with the first color (red, for example) representing the size and position of the set tentative target area (Step S24). If a plurality of tentative target areas is set, then frames corresponding to the individual tentative target areas are displayed.

Thereafter, every time when the first detection portion 201 informs the area setting portion 202 of the position of the written image, the area setting portion 202 enlarges or reduces the tentative target area if necessary (Step S25). In other words, the area setting portion 202 updates the tentative target area in response to writing made or erased. The update of the tentative target area is performed in response to detection of the written image by the first detection portion 201 while the second detection portion 203 does not detect that the object 30 moves out of the tentative target area space (NO in Step S26).

If the second detection portion 203 detects that the object 30 moves out of the tentative target area space (YES in Step S26), then the processing goes to Step S27 of FIG. 16, and the area setting portion 202 changes the tentative target area corresponding to the tentative target area space to a target area. In other words, the tentative target area is set to the target area without any changes.

The frame display control portion 204 controls the projection unit 11 to project a frame with the second color (blue, for example) representing the size and position of the target area (Step S28).

The second detection portion 203 starts counting the time when the target area is set. The second detection portion 203 checks whether or not the object 3 moves into the target area space within the standby time (Step S29). Examples of the case where the object 30 moves into the target area space within the standby time include a case where “the user approaches the target area in order to add a writing in the target area, modify the writing, or erasing the writing”.

If the second detection portion 203 detects that the object 30 moves into the target area space (YES in Step S29), then the area setting portion 202 determines that the user possibly changes the written image to set the tentative target area to the target area, (Step S33). In such a case, the process goes back from Step S33 of FIG. 16 to Step S24 of FIG. 15.

On the other hand, after the target area is set, if the object 30 does not move into a target area space corresponding to the target area within the standby time, the check result in Step S29 is “NO”. If the check result in Step S29 is “NO”, then the photographing control portion 205 controls the camera 12 to take an image of the board surface 50 (Step S30). The photographing control portion 205 then extracts a part corresponding to the target area from the photographic data captured by the camera 12 to store the extracted part into the non-volatile memory 17 (Step S31). In short, the photographing control portion 205 saves the photographic data on the target area.

For saving the photographic data, the photographing control portion 205 performs processing for associating the photographic data with the image 90. For example, the photographing control portion 205 adds identification information on the image 90 to the photographic data. Further, the photographing control portion 205 adds positional information for identifying the position of the target area in the board surface 50 to the photographic data. This is to show which part of the board surface 50 the photographic data corresponds to. For the case where writing is made in a plurality of parts during the display of one image 90, the photographing control portion 205 adds, to the photographic data, information for identifying the time-series of a plurality of sets of photographic data, e.g., photographing time, which is to show the order of the writing made.

As for the photographed target area, the area setting portion 202 cancels the setting in which the photographed target area is the target area. The area setting portion 202 does not change the photographed target area to the tentative target area, either.

The projection of the image 90 continues until the personal computer 7 gives instructions to switch between images or to finish emitting the light. The projector 2 checks whether or not the projection of the image 90 has been finished (Step S32). If the projection of the image 90 has not yet been finished (NO in Step S32), then the processing goes back to Step S21 to continue the series of processing for making a record of the written content during the display of the image 90 (Step S21-Step S33). If the projection of the image 90 has been finished (YES in Step S32), then the projector 3 finishes the operation shown in FIGS. 15 and 16.

When the projection of the image 90 is finished in accordance with the instructions to switch between images, the processing of Step S20-Step S33 is executed again in order to make a record of the written content during the display of the image.

According to the second embodiment, the same advantageous effect as that in the first embodiment is produced. To be specific, after writing in the whiteboard 5, the presenter 8 only moves to a position at which the tentative target area is not hidden, so that what is written in the whiteboard 5 can be recorded. The presenter 8 does not have to move largely to a position at which the board surface 50 is not hidden.

In the second embodiment, photographic data on an area in which writing has been actually made is saved. That means, unnecessary operation is not performed of saving photographic data on an area in which no writing has been made.

In the first and second embodiments, the ranging method related to detection of the object 30 is not limited to the TOF method. Another method may be adopted in which two photographic images having different viewpoints are compared with each other to determine the parallax of a subject, and a distance from the viewpoint to the object 30 is calculated by the triangulation method. In such a case, the object sensor 13 is a sensor having a light emitting device and two image pickup devices.

Alternatively, it is possible to identify the size and three-dimensional position of the object 30 in the photographic space 40 or 42 by image recognition based on the photographic image of the board surface 50 or the paper surface 60 photographed by the camera 12. For identifying the three-dimensional position, a method may be used in which a distance between a part of the object 30 and a shade part of the object 30 in the photographic image is converted into a distance between the object 30 and the board surface 50 or the paper surface 60.

The photographic data on the target area may be transferred to the personal computer 7 after storing the photographic data into the non-volatile memory 17 or without storing the same thereinto. When the photographic data D511, D531, D521, D512, D571, D621, or D711 on the target area is clipped from the photographic data on the board surface 50 or the paper surface 60, an internal area of the frame 510, 520, 530, or 710A may be clipped to make a record of the written image, or alternatively, an area containing the frame 510, 520, 530, or 710A may be clipped to make a record of the written image surrounded by the frame 510, 520, 530, or 710A. The written image is not limited to the character string 80, 82, 82b, or 83. The written image may be a line, a graphic, or a combination of a character, a line, and a graphic.

Instead of the arrangement in which the entirety of the board surface 50 or 60 is photographed to extract the photographic data D511, D531, D521, D512, D571, D621, and D711 on the target area, another arrangement is possible in which zooming in/out of selectively making the target area fit in the field of view is performed to obtain photographic data on the target area. Another arrangement is also possible of extracting, from the camera 12, the output of a light sensitive device corresponding to the target area among light sensitive devices provided in the light receiving surface of the camera 12.

In the second embodiment, instead of the arrangement in which a frame corresponding to a tentative target area has a color different from that of a frame corresponding to a target area to distinguish them from each other, the former frame and the latter frame may be distinguished from each other by making them have different brightness or patterns. Alternatively, a mode in which a frame is displayed and a mode in which no frame is displayed are prepared to enable a user of the projector 2 to select one of the modes appropriately. Yet alternatively, instead of displaying the frame, or along with displaying the frame, it is possible to make the brightness or the background color of each of the tentative target area and the target area differ from that of the vicinity of each of the areas. Yet alternatively, it is also possible to add different ground designs to the tentative target area and the target area.

In the second embodiment, the following arrangement is also possible. The position of a written image in a photographed target area is stored in advance. When detecting a written image in the position stored or the vicinity thereof, the first detection portion 201 informs the area setting portion 202 of the position of an area containing a combined image of the detected written image and the image in the position stored, as the detection result of a new written image. This enables, when additional writing is made to the previous writing, recording the entire writing including the additional writing instead of recording the additional writing only.

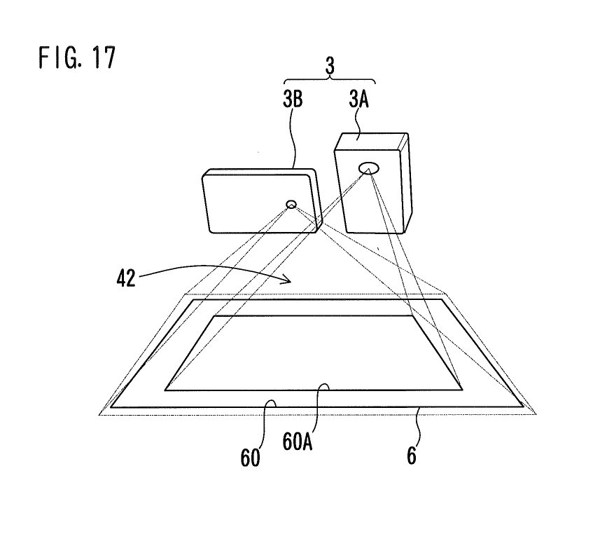

In the first and second embodiments, the projectors 1 and 2 are exemplified in which the projection unit 11 and the camera 12 are integral with each other. The present invention is not limited thereto, and is also applicable to such a system configuration shown in FIG. 17 where a display means for projecting an image is provided in a device independently of a device having a photographing means for photographing a projection surface.

Referring to FIG. 17, a system 3 for projection and photographing is provided with a portable projector 3A and a portable information terminal 3B having a camera (photographing means). The information terminal 3B is, for example, a smartphone.

The projector 3A projects an image onto, for example, paper 6 used as a writable screen placed on a desk. The projector 3A is placed at a position higher than the position of the paper 6. The range within which the projector 2A projects light is so adjusted that a part of the paper surface 60 of the paper 6 is used as a projection surface 60A.

The information terminal 3B photographs the paper 6. The information terminal 3B is also placed at a position higher than the position of the paper 6. The field of view of the camera of the information terminal 3B is so adjusted that the camera may take an image of the entire region of the paper surface 60 to which writing may be made.

The system 3 is configured to implement functions similar to those of the projector 1 according to the first embodiment, or, functions similar to those of the projector 2 according to the second embodiment. For implementing the functions similar to those of the projector 1, the system 3 is configured of the functions equal to those of the first detection portion 101, the area setting portion 102, the second detection portion 103, the frame display control portion 104, and the photographing control portion 105 all of which are shown in FIG. 5. For implementing the functions similar to those of the projector 2, the system 3 is configured of the functions equal to those of the first detection portion 201, the area setting portion 202, the second detection portion 203, the frame display control portion 204, and the photographing control portion 205 all of which are shown in FIG. 11.

Both the case of implementing the functions similar to those of the projector 1 and the case of implementing the functions similar to those of the projector 2, it is possible to provide a part of the functional elements in the projector 3A and the rest thereof in the information terminal 3B. For example, the projector 3A may be configured of the frame display control portion 104 or 204, and the information terminal 3B may be configured of the first detection portion 101 or 201, the area setting portion 102 or 202, the second detection portion 103 or 203, the frame display control portion 104 or 204, and the photographing control portion 105 or 205.

The configurations of the projectors 1 and 2 and the system 3, the operation thereof, the shape thereof, the use thereof, and the like can be appropriately modified without departing from the spirit of the present invention. The time interval for detection of the presence/absence of the object 30, detection of change in position of the object 30, or detection of the written image is not limited to the exemplified example, and can be optimized depending on the application of the projectors 1 and 2 and the system 3. For example, in the first embodiment, the time interval for detection of the presence/absence of the object 30 is set to be longer than the exemplified example. This reduces recording of photographic data on an area where no writing is actually made. As discussed above, according to the first and second embodiments, it is possible to make a record of an image written in a surface more reliably and more easily for the user than is conventionally possible.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A photographing system comprising:
a photographing device configured to photograph a surface;
a detector configured to detect a change in a position of an object in a space between the surface and the photographing device; and
an obtaining portion configured to obtain an image of an area of the surface by the photographing device when the detector detects the change, the area being not viewed by the photographing device before the change due to interruption of the object and being viewed by the photographing device after the change.

2. The photographing system according to claim 1, comprising a separate area setting portion configured to delimit separate areas of the surface depending on a size of the object in the space; wherein
when the detector detects, as the change, that the object moves out of a second space between one of the separate areas and the photographing device, the obtaining portion obtains the image with said one of the separate areas set as the area, and
when the object moves into the space, or, when the object moves from the second space to a third space between another one of the separate areas and the photographing device, the separate area setting portion again delimits separate areas of the surface.

3. The photographing system according to claim 1, wherein
the surface is delimited to set separate areas, and
when the detector detects, as the change, that the object moves out of a second space between one of the separate areas and the photographing device, the obtaining portion obtains the image with said one of the separate areas set as the area.

4. The photographing system according to claim 2, comprising a display device configured to display an identification image on the surface, the identification image indicating a separate area that is a part of the separate areas and is not viewed by the photographing device due to interruption of the object.

5. The photographing system according to claim 4, wherein, when the detector detects that the object moves out of the second space, the display device displays a second identification image on the surface, the second identification image differing from the identification image and indicating a separate area that is a part of the separate areas and is related to the second space.

6. The photographing system according to claim 1, comprising a writing detector configured to detect a writing in a surface; wherein
when the detector detects that the object moves out of a second space between a second area including the writing and the photographing device, the obtaining portion obtains the image with the second area set as the area.

7. The photographing system according to claim 6, wherein
the writing detector detects the writing periodically, and
the second area is an area obtained by expanding, by a predetermined amount, a third area in which the writing is inscribed.

8. The photographing system according to claim 6, comprising a display device configured to display an identification image indicating the second area on the surface.

9. The photographing system according to claim 8, wherein, when the detector detects that the object moves out of the second space, the display device displays a second identification image on the surface, the second identification image differing from the identification image and indicating the second area.

10. A photographing method using a photographing device for photographing a surface; the method comprising:
a first step of detecting a change in a position of an object in a space between the surface and the photographing device; and
a second step of obtaining an image of an area of the surface by the photographing device when the change is detected in the first step, the area being not viewed by the photographing device before the change due to interruption of the object and being viewed by the photographing device after the change.

11. A non-transitory computer-readable storage medium storing thereon a computer program used in a computer, the computer controlling a photographing device for photographing a surface, the computer program causing the computer to execute processing comprising:
first processing of detecting a change in a position of an object in a space between the surface and the photographing device; and
second processing of obtaining an image of an area of the surface by the photographing device when the change is detected in the first step, the area being not viewed by the photographing device before the change due to interruption of the object and being viewed by the photographing device after the change.
